(19) United States
(12) Patent Application Publication
(10) Pub. No.: US 2024/0334264 A1
(43) Pub. Date: Oct. 3, 2024

(54) DUAL CONNECTIVITY CELL PRIORITIZATION

(71) Applicant: QUALCOMM Incorporated, San Diego, CA (US)

(72) Inventors: Rishika TINDOLA, Hyderabad (IN); Muralidharan MURUGAN, Hyderabad (IN); Nitin PANT, San Diego, CA (US); Shyamal RAMACHANDRAN, San Diego, CA (US); Jun DENG, Shanghai (CN); Hewu GU, Shanghai (CN); Xuepan GUAN, San Diego, CA (US)

(21) Appl. No.: 18/292,182

(22) PCT Filed: Oct. 1, 2021
(86) PCT No.: PCT/CN2021/122484

§ 371 Date: Jan. 25, 2024

(51) Int. Cl. H04W 36/00; H04W 36/08; H04W 48/10

(52) U.S. Cl. CPC H04W 36/0069; H04W 36/08; H04W 48/10

(57) ABSTRACT

Various aspects of the present disclosure generally relate to wireless communication. In some aspects, a user equipment (UE) may identify a multi-radio access technology (multi-RAT) dual connectivity (DC) (MR-DC) capable cell. The UE may assign a priority to the MR-DC capable cell based at least in part on whether information indicating whether dual connectivity is supported for the UE in a tracking area (TA) is available, the information indicating whether dual connectivity is supported for the UE in the TA, whether system information block (SIB) information indicating frequency bands supported by a network for MR-DC operation cell is available, or MR-DC connectivity information indicating whether at least one frequency band is available to support MR-DC operation. The UE may perform a cell selection procedure or a cell reselection procedure based at least in part on the priority assigned to the MR-DC capable cell. Numerous other aspects are described.

### FIELD OF THE DISCLOSURE

Aspects of the present disclosure generally relate to wireless communication and to techniques and apparatuses for dual connectivity cell prioritization.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a UE. The method may include identifying a multiple radio access technology (multi-RAT) dual connectivity (DC) (MR-DC) capable cell. The method may include assigning a priority to the MR-DC capable cell based at least in part on at least one of whether information indicating whether dual connectivity is supported for the UE in a tracking area (TA) associated with the MR-DC capable cell is available, the information indicating whether dual connectivity is supported for the UE in the TA associated with the MR-DC capable cell, whether system information block (SIB) information indicating frequency bands supported by a network for MR-DC operation in the MR-DC capable cell is available, or MR-DC connectivity information, associated with the MR-DC capable cell, indicating whether at least one frequency band is available to support MR-DC operation. The method may include performing a cell selection procedure or a cell reselection procedure based at least in part on the priority assigned to the MR-DC capable cell.

Some aspects described herein relate to a UE for wireless communication. The user equipment may include a memory and one or more processors coupled to the memory. The one or more processors may be configured to identify an MR-DC capable cell. The one or more processors may be configured to assign a priority to the MR-DC capable cell based at least in part on at least one of whether information indicating whether dual connectivity is supported for the UE in a TA associated with the MR-DC capable cell is available, the information indicating whether dual connectivity is supported for the UE in the TA associated with the MR-DC capable cell, whether SIB information indicating frequency bands supported by a network for MR-DC operation in the MR-DC capable cell is available, or MR-DC connectivity information, associated with the MR-DC capable cell, indicating whether at least one frequency band is available to support MR-DC operation. The one or more processors may be configured to perform a cell selection procedure or a cell reselection procedure based at least in part on the priority assigned to the MR-DC capable cell.

Some aspects described herein relate to a non-transitory computer-readable medium that stores a set of instructions for wireless communication by a UE. The set of instructions, when executed by one or more processors of the UE, may cause the UE to identify an MR-DC capable cell. The set of instructions, when executed by one or more processors of the UE, may cause the UE to assign a priority to the MR-DC capable cell based at least in part on at least one of whether information indicating whether dual connectivity is supported for the UE in a TA associated with the MR-DC capable cell is available, the information indicating whether dual connectivity is supported for the UE in the TA associated with the MR-DC capable cell, whether SIB information indicating frequency bands supported by a network for MR-DC operation in the MR-DC capable cell is available, or MR-DC connectivity information, associated with the MR-DC capable cell, indicating whether at least one frequency band is available to support MR-DC operation. The set of instructions, when executed by one or more processors of the UE, may cause the UE to perform a cell selection procedure or a cell reselection procedure based at least in part on the priority assigned to the MR-DC capable cell.

Some aspects described herein relate to an apparatus for wireless communication. The apparatus may include means for identifying an MR-DC capable cell. The apparatus may include means for assigning a priority to the MR-DC capable cell based at least in part on at least one of whether information indicating whether dual connectivity is supported for the apparatus in a TA associated with the MR-DC capable cell is available, the information indicating whether dual connectivity is supported for the apparatus in the TA associated with the MR-DC capable cell, whether SIB information indicating frequency bands supported by a network for MR-DC operation in the MR-DC capable cell is available, or MR-DC connectivity information, associated with the MR-DC capable cell, indicating whether at least one frequency band is available to support MR-DC operation. The apparatus may include means for performing a cell selection procedure or a cell reselection procedure based at least in part on the priority assigned to the MR-DC capable cell.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of dual connectivity, in accordance with the present disclosure.

FIGS. 4A-4C are diagrams illustrating examples associated with dual connectivity cell prioritization, in accordance with the present disclosure.

FIG. 5 is a diagram illustrating an example process associated with dual connectivity cell prioritization, in accordance with the present disclosure.

FIG. 6 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

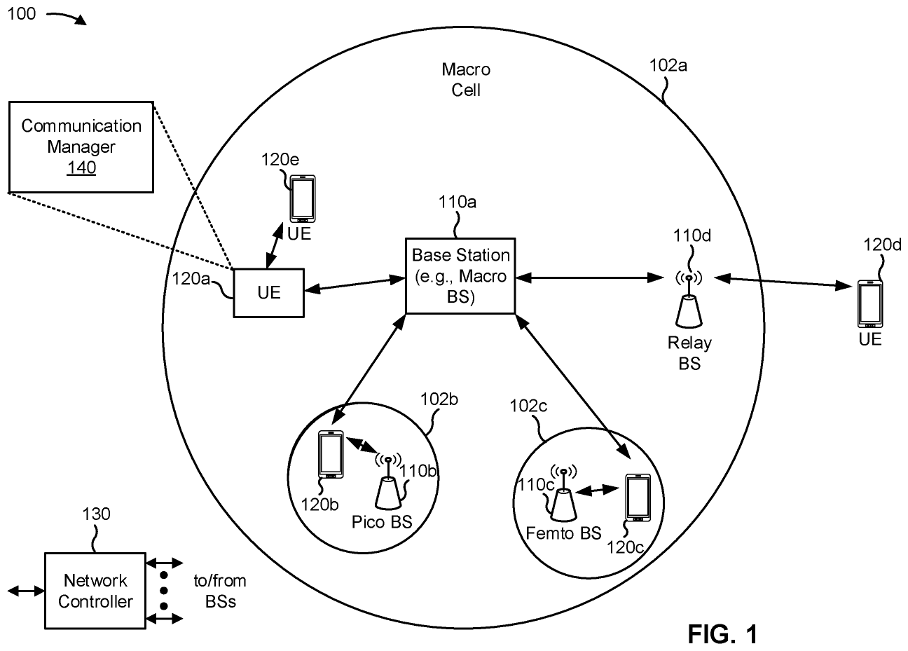

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may identify an MR-DC capable cell: assign a priority to the MR-DC capable cell based at least in part on at least one of whether information indicating whether dual connectivity is supported for the UE in a TA associated with the MR-DC capable cell is available, the information indicating whether dual connectivity is supported for the UE in the TA associated with the MR-DC capable cell, whether SIB information indicating frequency bands supported by a network for MR-DC operation in the MR-DC capable cell is available, or MR-DC connectivity information, associated with the MR-DC capable cell, indicating whether at least one frequency band is available to support MR-DC operation; and perform a cell selection procedure or a cell reselection procedure based at least in part on the priority assigned to the MR-DC capable cell. Additionally, or alternatively, the communication manager 140 may perform one or more other operations described herein.

As indicated above, FIG. 1 is provided as an example. Other examples may differ from what is described with regard to FIG. 1.

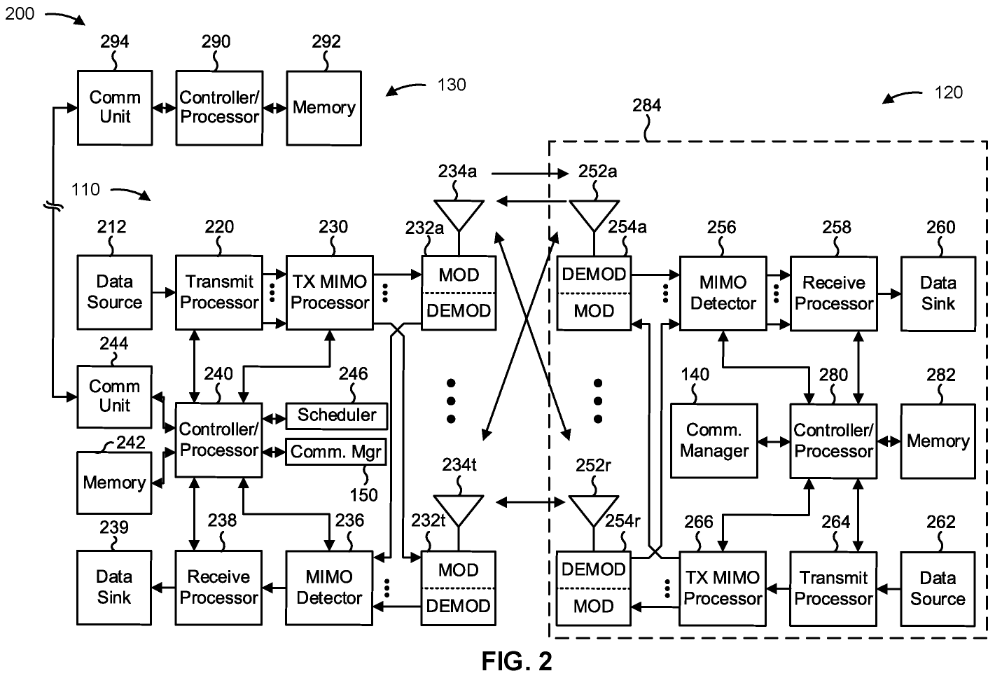

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

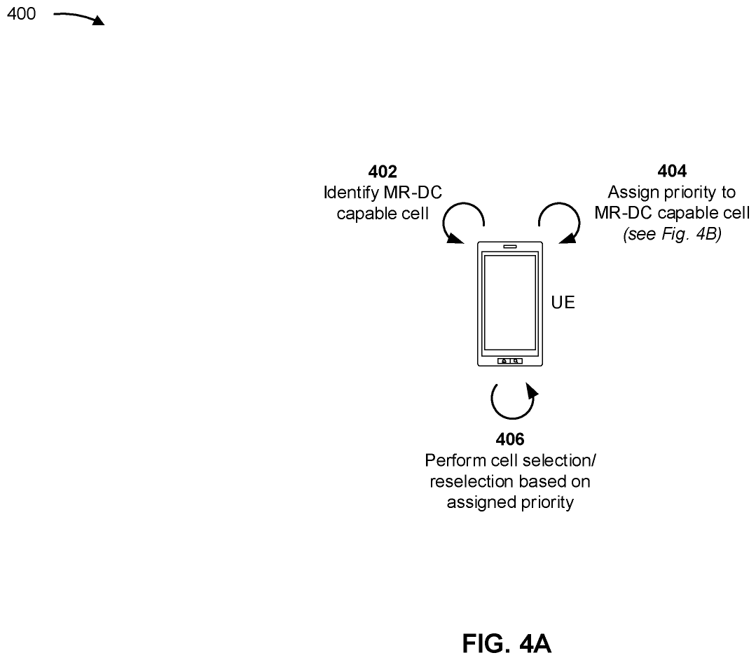

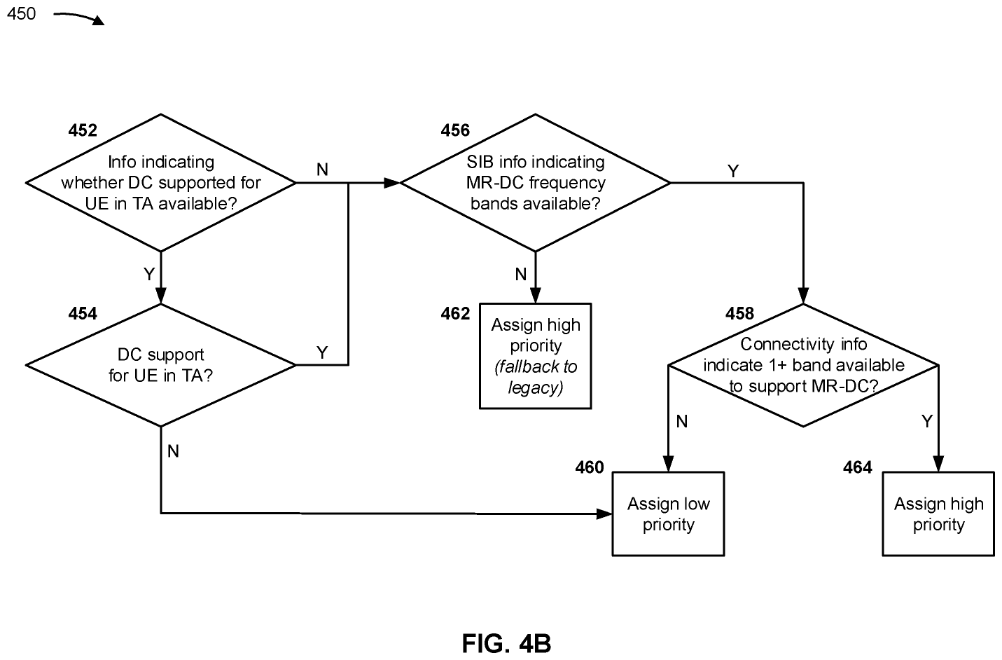

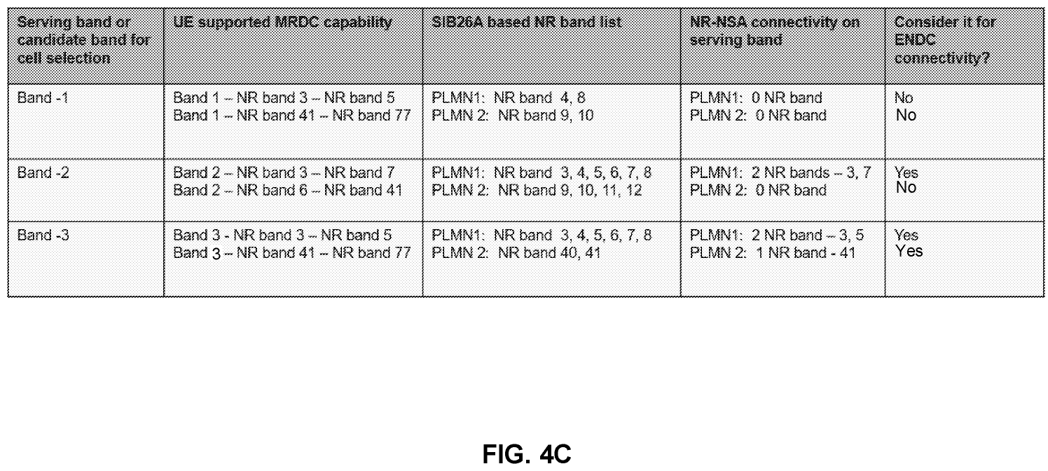

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4A-6).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4A-6).

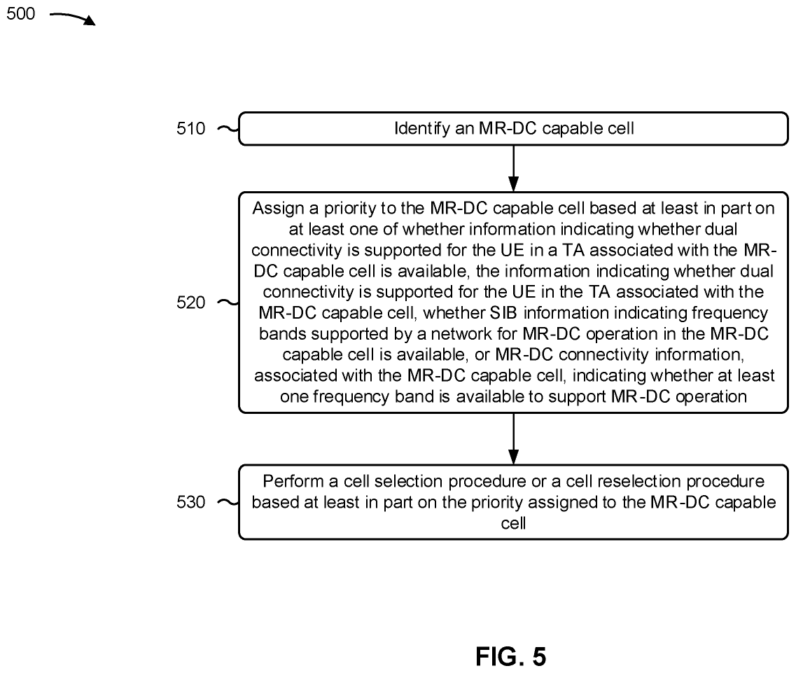

The controller/processor 240 of the base station 110, the controller/processor 280 of the UE 120, and/or any other component(s) of FIG. 2 may perform one or more techniques associated with dual connectivity cell prioritization, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5 and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5 and/or other processes as described herein. In some examples, executing instructions may include running the instructions, converting the instructions, compiling the instructions, and/or interpreting the instructions, among other examples.

In some aspects, the UE includes means for identifying an MR-DC capable cell (e.g., using antenna 252, modem 254, MIMO detector 256, receive processor 258, transmit processor 264, TX MIMO processor 266, controller/processor 280, or memory 282): means for assigning a priority to the MR-DC capable cell based at least in part on at least one of whether information indicating whether dual connectivity is supported for the UE in a TA associated with the MR-DC capable cell is available, the information indicating whether dual connectivity is supported for the UE in the TA associated with the MR-DC capable cell, whether SIB information indicating frequency bands supported by a network for MR-DC operation in the MR-DC capable cell is available, or MR-DC connectivity information, associated with the MR-DC capable cell, indicating whether at least one frequency band is available to support MR-DC operation (e.g., using antenna 252, modem 254, MIMO detector 256, receive processor 258, transmit processor 264, TX MIMO processor 266, controller/processor 280, or memory 282); and/or means for performing a cell selection procedure or a cell reselection procedure based at least in part on the priority assigned to the MR-DC capable cell (e.g., using antenna 252, modem 254, MIMO detector 256, receive processor 258, transmit processor 264, TX MIMO processor 266, controller/processor 280, or memory 282). The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

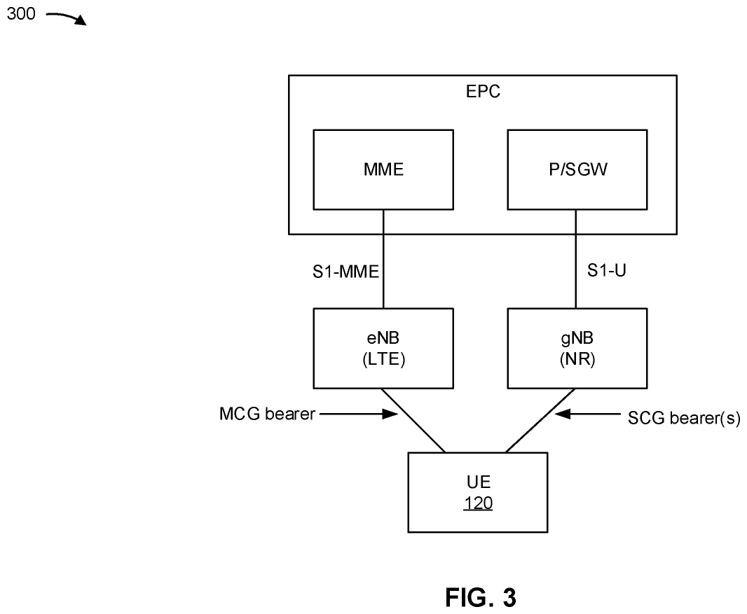

FIG. 3 is a diagram illustrating an example 300 of dual connectivity, in accordance with the present disclosure. The example shown in FIG. 3 is for an Evolved Universal Mobile Telecommunications System Terrestrial Radio Access (E-UTRA)-NR dual connectivity (EN-DC) mode. In the EN-DC mode, a UE 120 communicates using an LTE RAT on a master cell group (MCG), and the UE 120 communicates using an NR RAT on a secondary cell group (SCG). Notably, aspects described herein may apply to an EN-DC mode (e.g., where the MCG is associated with an LTE RAT and the SCG is associated with an NR RAT), an NR-E-UTRA dual connectivity (NE-DC) mode (e.g., where the MCG is associated with an NR RAT and the SCG is associated with an LTE RAT), or another type of multi-RAT DC (MR-DC) mode (e.g., where the MCG is associated with a first RAT and the SCG is associated with a second RAT). The EN-DC mode is sometimes referred to as an NR or 5G non-standalone (NSA) mode. Thus, as used herein, “MR-DC mode” may refer to an EN-DC mode, an NE-DC mode, and/or another type of multi-RAT dual connectivity mode.

As shown in FIG. 3, a UE 120 may communicate with both an eNB (e.g., a 4G base station 110) and a gNB (e.g., a 5G base station 110), and the eNB and the gNB may communicate (e.g., directly or indirectly) with a 4G/LTE core network, shown as an evolved packet core (EPC) that includes a mobility management entity (MME), a packet data network gateway (PGW), a serving gateway (SGW), and/or other devices. In FIG. 3, the PGW and the SGW are shown collectively as P/SGW. In some aspects, the eNB and the gNB may be co-located at the same base station 110. In some aspects, the eNB and the gNB may be included in different base stations 110 (e.g., may not be co-located).

As further shown in FIG. 3, in some aspects, a wireless network that permits operation in a 5G NSA mode may permit such operations using an MCG for a first RAT (e.g., an LTE RAT or a 4G RAT) and an SCG for a second RAT (e.g., an NR RAT or a 5G RAT). In this case, the UE 120 may communicate with the eNB via the MCG, and may communicate with the gNB via the SCG. In some aspects, the MCG may anchor a network connection between the UE 120 and the 4G/LTE core network (e.g., for mobility, coverage, and/or control plane information), and the SCG may be added as additional carriers to increase throughput (e.g., for data traffic and/or user plane information). In some aspects, the gNB and the eNB may not transfer user plane information between one another. In some aspects, a UE 120 operating in a dual connectivity mode may be concurrently connected with an LTE base station 110 (e.g., an eNB) and an NR base station 110 (e.g., a gNB) (e.g., in the case of EN-DC or NE-DC), or may be concurrently connected with one or more base stations 110 that use the same RAT (e.g., in the case of NR-DC). In some aspects, the MCG may be associated with a first frequency band (e.g., a sub-6 GHz band and/or an FR1 band) and the SCG may be associated with a second frequency band (e.g., a millimeter wave band and/or an FR2 band).

The UE 120 may communicate via the MCG and the SCG using one or more radio bearers (e.g., data radio bearers (DRBs) and/or signaling radio bearers (SRBs)). For example, the UE 120 may transmit or receive data via the MCG and/or the SCG using one or more DRBs. Similarly, the UE 120 may transmit or receive control information (e.g., radio resource control (RRC) information and/or measurement reports) using one or more SRBs. In some aspects, a radio bearer may be dedicated to a specific cell group (e.g., a radio bearer may be an MCG bearer or an SCG bearer). In some aspects, a radio bearer may be a split radio bearer. A split radio bearer may be split in the uplink and/or in the downlink. For example, a DRB may be split on the downlink (e.g., the UE 120 may receive downlink information for the MCG or the SCG in the DRB) but not on the uplink (e.g., the uplink may be non-split with a primary path to the MCG or the SCG, such that the UE 120 transmits in the uplink only on the primary path). In some aspects, a DRB may be split on the uplink with a primary path to the MCG or the SCG. A DRB that is split in the uplink may transmit data using the primary path until a size of an uplink transmit buffer satisfies an uplink data split threshold. If the uplink transmit buffer satisfies the uplink data split threshold, the UE 120 may transmit data to the MCG or the SCG using the DRB.

In some aspects, the UE 120 may perform operations associated with dual connectivity cell prioritization, as described herein. For example, the UE 120 may identify an MR-DC capable cell (e.g., a cell capable of supporting operation of the UE 120 in the MR-DC mode), and may assign a priority to the MR-DC capable cell. In some aspects, the UE 120 may assign the priority based at least in part on whether information indicating whether DC is supported for the UE 120 in a tracking area (TA) associated with the MR-DC capable cell is available, the information indicating whether dual connectivity is supported for the UE in the TA associated with the MR-DC capable cell, whether system information block (SIB) information indicating frequency bands supported by a network for MR-DC operation in the MR-DC capable cell is available, or MR-DC connectivity information, associated with the MR-DC capable cell, indicating whether at least one frequency band is available to support MR-DC operation. The UE 120 may assign priorities to one or more MR-DC capable cells in this manner, and may then perform a cell selection procedure or a cell reselection procedure based at least in part on the assigned priorities.

As indicated above, FIG. 3 is provided as an example. Other examples may differ from what is described with respect to FIG. 3.

During a cell selection or reselection procedure, both LTE-only cells (e.g., cells that do not support the EN-DC mode of operation) and EN-DC capable cells (e.g., cells that support the EN-DC mode of operation) may be available for selection/reselection by a UE. Generally, to support 5G coverage for the UE, it is preferable for the UE to choose an EN-DC capable cell for camping by the UE.

In some systems, to facilitate UE prioritization of EN-DC capable cells, the UE maintains a database (sometimes referred to as a 5G fingerprint database) that stores information identifying LTE cells that support dual connectivity with NR (i.e., information indicating whether a given cell is an EN-DC capable cell). Here, during a cell selection or reselection procedure, the EN-DC capable cells indicated in the database are prioritized over LTE-only cells. However, the use of such a database for cell prioritization does not provide sufficient reliability in association with causing the UE to select/reselect an EN-DC capable cell. For example, even if the UE camps on an EN-DC capable cell, ensuring that the EN-DC capable cell will be configured with EN-DC capability or that the network will add an SCG on the EN-DC capable cell is not possible.

Further, in some systems, a base station may transmit, and a UE may receive, a system information block 26a (SIB26a) that includes a list of NR frequency bands that can be used for operation in the EN-DC mode in the serving cell of the UE (e.g., per public land mobile network (PLMN) or for all PLMNs). Generally, if SIB26a includes a list of NR bands for the selected PLMN and the UE supports operation in the EN-DC mode using the serving cell and at least one NR band in the list of NR bands, then the UE forwards an upper layer indication (ULI) to an upper layer (e.g., as if the UE had received the ULI from SIB2), which allows the UE to display a 5G icon on a user interface. Otherwise, the UE indicates the absence of the ULI to the upper layer, meaning that the UE does not display the 5G icon on the user interface. Notably, SIB26a can be received by the UE only after cell selection/reselection. However, if the cell selected by the UE is not an EN-DC capable cell and SIB26a is not scheduled, then the UE cannot display the 5G icon on the user interface. Therefore, there is no guarantee that the UE will display the 5G icon (e.g., due to missing SIB26a or no MR-DC combination being supported by the network corresponding to the serving band to add a SCG in the serving PLMN), which degrades user experience.

Some techniques and apparatuses described herein provide for improved cell selection or reselection on reliable MR-DC capable cells. In some aspects, a UE may identify an MR-DC capable cell (e.g., an EN-DC capable cell) and assign a priority to the MR-DC capable cell. In some aspects, the UE may assign the priority based at least in part on whether information indicating whether dual connectivity is supported for the UE in a tracking area (TA) associated with the MR-DC capable cell is available, the information indicating whether dual connectivity is supported for the UE in the TA associated with the MR-DC capable cell, whether SIB information indicating frequency bands supported by a network for MR-DC operation in the MR-DC capable cell is available, or MR-DC connectivity information indicating whether at least one frequency band is available to support MR-DC operation. The UE may assign priorities to a group of MR-DC capable cells in this manner, and may then perform a cell selection or reselection procedure based at least in part on the assigned priorities. In this way, reliability of the UE obtaining MR-DC connectivity is improved, thereby improving coverage (e.g., NR coverage in the case of EN-DC) and increasing throughput. Further, in some aspects, accuracy associated with display of an MR-DC related icon (e.g., the 5G icon) on a user interface is increased, thereby improving user experience. Additional details are provided below.

FIGS. 4A-4C are diagrams illustrating examples associated with dual connectivity cell prioritization, in accordance with the present disclosure.

As shown in FIG. 4A by reference 402, a UE (e.g., a UE 120) may identify an MR-DC capable cell. In some aspects, the MR-DC capable cell may be an EN-DC capable cell. In some aspects, the MR-DC capable cell may be another type of MR-DC capable cell, such as an NE-DC capable cell, or the like.

In some aspects, the UE may identify the MR-DC capable cell based at least in part on a database, stored by the UE, that identifies one or more MR-DC capable cells. For example, in the case of an EN-DC capable cell, the UE may identify the EN-DC capable cell from a 5G fingerprint database stored on or maintained by the UE. As another example, the UE may identify the EN-DC capable cell from an MR-DC database stored on or maintained by the UE.

In some aspects, the UE may store information identifying the MR-DC capable cell in a database (e.g., the MR-DC database) based at least in part on an SCG addition associated with the MR-DC capable cell. That is, in some aspects, the UE can identify a cell as an MR-DC capable cell based at least in part on the cell being included in an SCG addition, and may store an indication of the MR-DC capable cell in the database, accordingly.

In some aspects, the UE may store information identifying the MR-DC capable cell in a database (e.g., the MR-DC database) based at least in part on the UE receiving a measurement configuration for the MR-DC capable cell that is associated with a particular RAT. That is, in some aspects, the UE can identify a cell as an MR-DC capable cell based at least in part on receiving a measurement configuration for the cell (e.g., an NR measurement configuration in the case of an EN-DC capable cell), and may store an indication of the MR-DC capable cell in the database, accordingly.

In some aspects, the UE may store information identifying the MR-DC capable cell in a database (e.g., the MR-DC database) based at least in part on an upper layer indication (ULI) received by the UE in a SIB, such as SIB2. That is, in some aspects, the UE can identify a cell as an MR-DC capable cell based at least in part on a ULI associated with the cell being received in the SIB, and may store an indication of the MR-DC capable cell in the database, accordingly.

As shown by reference 404, the UE may assign a priority to the MR-DC capable cell identified from the database. Example bases for assignment of the priority by the UE are described below with respect to FIG. 4A, and examples of assignment of the priority by the UE using these bases are described below with respect to FIG. 4B.

In some aspects, the UE may assign the priority to the MR-DC capable cell based at least in part on whether information indicating whether dual connectivity is supported for the UE in a TA associated with the MR-DC capable cell is available. For example, in the case of an EN-DC capable cell, the UE may assign the priority to the EN-DC capable cell based at least in part on whether DC-NR information (e.g., information indicating whether dual connectivity is supported for the UE in a TA associated with the EN-DC capable cell) is available.

Additionally, or alternatively, the UE may assign the priority to the MR-DC capable cell based at least in part on the information indicating whether dual connectivity is supported for the UE in the TA associated with the MR-DC capable cell. That is, when the information indicating whether dual connectivity is supported for the UE in the TA associated with the MR-DC capable cell is available, the UE can in some aspects assign the priority to the MR-DC capable cell based at least in part on the information indicating whether dual connectivity is supported for the UE in the TA. As a particular example, in the case of an EN-DC capable cell, the UE may assign the priority to the EN-DC capable cell based at least in part on whether DC-NR information that is available to the UE indicates that dual connectivity is supported for the UE in the TA (e.g., DC-NR=TRUE) or indicates that dual connectivity is not supported for the UE in the TA (e.g., DC-NR=FALSE).

Additionally, or alternatively, the UE may assign the priority to the MR-DC capable cell based at least in part on whether SIB information indicating frequency bands supported by the network for MR-DC operation in the MR-DC capable cell is available. For example, in the case of an EN-DC capable cell, the UE may assign the priority to the EN-DC capable cell based at least in part on whether a SIB26a associated with the EN-DC capable cell is available to the UE (e.g., whether the UE has previously received SIB26a for the EN-DC capable cell).

Additionally, or alternatively, the UE may assign the priority to the MR-DC capable cell based at least in part on MR-DC connectivity information, associated with the MR-DC capable cell, indicating whether at least one frequency band is available to support MR-DC operation. For example, in the case of an EN-DC capable cell, the UE may assign the priority to the EN-DC capable cell based at least in part on EN-DC connectivity information that indicates whether a UE supported MR-DC capability and SIB26a indicate that at least one NR band should be available for a serving cell in a selected PLMN to support EN-DC.

In some aspects, the UE may determine the MR-DC connectivity information based at least in part on the SIB information indicating the frequency bands supported by the network for MR-DC operation in the MR-DC capable cell and UE capability information indicating frequency bands supported by the UE for MR-DC operation in the MR-DC capable cell. For example, in the case of an EN-DC capable cell, the UE may determine the MR-DC connectivity information based at least in part on SIB26a (e.g., indicating frequency bands supported by the network for EN-DC operation in the EN-DC capable cell) and UE capability information indicating frequency bands supported by the UE for EN-DC operation. Particular examples of determining the MR-DC connectivity information are described below with respect to FIG. 4C.

As further shown in FIG. 4A by reference 406, the UE may perform a cell selection or reselection procedure based at least in part on the priority assigned to the MR-DC capable cell. For example, the UE may identify a group of MR-DC capable cells and may assign a priority to each MR-DC capable cell in the group of MR-DC capable cells in the manner described above. The UE may then perform the cell selection or reselection procedure based at least in part on the priorities assigned to the MR-DC capable cell. For example, each MR-DC capable cell of a group of MR-DC capable cells may be assigned either a high priority (e.g., rank 1) or a low priority (e.g., rank 2). Here, during the cell selection or reselection procedure, the UE may prioritize the high priority MR-DC capable cells over the low priority MR-DC capable cells (e.g., such that a high priority MR-DC capable cell will be selected over a lower priority MR-DC capable cell).

FIG. 4B is a flow chart illustrating an example process 450 for assigning a priority to an MR-DC capable cell. As described above, in some aspects, the UE may assign a priority to an MR-DC capable cell based at least in part on: whether information indicating whether dual connectivity is supported for the UE in a TA associated with the MR-DC capable cell is available (block 452), the information indicating whether dual connectivity is supported for the UE in the TA (block 454), whether SIB information indicating frequency bands supported by a network for MR-DC operation in the MR-DC capable cell is available (block 456), or MR-DC connectivity information indicating whether at least one frequency band is available to support MR-DC operation (block 458).

In one example, the UE may assign a low priority (e.g., rank 2) to a given MR-DC capable cell based at least in part on the information indicating whether dual connectivity is supported for the UE in the TA being available and indicating that dual connectivity is not supported for the UE in the TA. For example, the UE may determine that the information indicating whether dual connectivity is supported for the UE in the TA is available (block 452→YES) and that the information indicates that dual connectivity is not supported for the UE in the TA (block 454→NO). As a result, the UE may assign the low priority to the MR-DC capable cell (block 460).

In another example, the UE may assign the low priority to a given MR-DC capable cell based at least in part on the information indicating whether dual connectivity is supported for the UE in the TA being unavailable, the SIB information being available, and the MR-DC connectivity information indicating that no frequency band is available to support MR-DC operation. For example, the UE may determine that the information indicating whether dual connectivity is supported for the UE in the TA is unavailable (block 452→NO), that the SIB information is available (block 456→YES), and that the MR-DC connectivity information indicates that no frequency band is available to support MR-DC operation (block 458→NO). As a result, the UE may assign the low priority to the MR-DC capable cell (block 460).

In another example, the UE may assign the low priority to a given MR-DC capable cell based at least in part on the information indicating whether dual connectivity is supported for the UE in the TA being available and indicating the dual connectivity is supported for the UE in the TA, the SIB information being available, and the MR-DC connectivity information indicating that no frequency band is available to support MR-DC operation. For example, the UE may determine that the information indicating whether dual connectivity is supported for the UE in the TA is available (block 452→YES) and that the information indicates that dual connectivity is supported for the UE in the TA (block 454→YES), that the SIB information is available (block 456→YES), and that the MR-DC connectivity information indicates that no frequency band is available to support MR-DC operation (block 458→NO). As a result, the UE may assign the low priority to the MR-DC capable cell (block 460).

In another example, the UE may assign a high priority (e.g., rank 1) to a given MR-DC capable cell based at least in part on the information indicating whether dual connectivity is supported for the UE in the TA being unavailable, and the SIB information being unavailable. For example, the UE may determine that the information indicating whether dual connectivity is supported for the UE in the TA is unavailable (block 452→NO) and that the SIB information is unavailable (block 456→NO). As a result, the UE may assign the high priority to the MR-DC capable cell (block 462) (e.g., the UE may fall back to a legacy algorithm and assign the high priority to the MR-DC capable cell).

In another example, the UE may assign the high priority to a given MR-DC capable cell based at least in part on the information indicating whether dual connectivity is supported for the UE in the TA being available and indicating that dual connectivity is supported for the UE in the TA, and the SIB information being unavailable. For example, the UE may determine that the information indicating whether dual connectivity is supported for the UE in the TA is available (block 452→YES) and the information indicates that dual connectivity is supported for the UE in the TA (block 454→YES), and that the SIB information is unavailable (block 456→NO). As a result, the UE may assign the high priority to the MR-DC capable cell (block 462) (e.g., the UE may fall back to a legacy algorithm and assign the high priority to the MR-DC capable cell).

In another example, the UE may assign the high priority to a given MR-DC capable cell based at least in part on the information indicating whether dual connectivity is supported for the UE in the TA being unavailable, the SIB information being available, and the MR-DC connectivity information indicating that at least one frequency band is available to support MR-DC operation. For example, the UE may determine that the information indicating whether dual connectivity is supported for the UE in the TA is unavailable (block 452→NO), that the SIB information is available (block 456→YES), and that the MR-DC connectivity information indicates that one or more frequency band are available to support MR-DC operation (block 458→YES). As a result, the UE may assign the high priority to the MR-DC capable cell (block 464).

In another example, the UE may assign the high priority to a given MR-DC capable cell based at least in part on the information indicating whether dual connectivity is supported for the UE in the TA being available and indicating that dual conn is supported for the UE in the TA, the SIB information being available, and the MR-DC connectivity information indicating that at least one frequency band is available to support MR-DC operation. For example, the UE may determine that the information indicating whether dual connectivity is supported for the UE in the TA is available (block 452→YES) and the information indicates that dual connectivity is supported for the UE In the TA (block 454→YES), that the SIB information is available (block 456→YES), and that the MR-DC connectivity information indicates that one or more frequency band are available to support MR-DC operation (block 458→YES). As a result, the UE may assign the high priority to the MR-DC capable cell (block 464).

FIG. 4C illustrates particular examples associated with determining MR-DC connectivity information for an MR-DC capable cell, as described herein. As described above, the MR-DC connectivity information for a given MR-DC capable cell includes information indicating whether at least one frequency band is available to support MR-DC operation. For example, in the case of an EN-DC capable cell, the MR-DC connectivity information includes an indication of whether a combination of a UE supported MR-DC capability and SIB26a indicate that at least one NR band should be available for the serving cell in a PLMN to support EN-DC.

In some aspects, the UE may determine the MR-DC connectivity information based at least in part on the SIB information indicating the frequency bands supported by the network for MR-DC operation in the MR-DC capable cell and UE capability information indicating frequency bands supported by the UE for MR-DC operation in the MR-DC capable cell. For example, in the case of an EN-DC capable cell, the UE may determine the MR-DC connectivity information based at least in part on SIB26a (e.g., indicating frequency bands supported by the network for EN-DC operation in the EN-DC capable cell) and UE capability information indicating frequency bands supported by the UE for EN-DC operation.

As a particular example, with respect to a first cell (corresponding to the row identified as “Band-1” in FIG. 4C), the UE capability information (included in the column identified “UE supported MR-DC capability”) indicates that NR band 3 and NR band 5 are supported by the UE for EN-DC operation for a first PLMN (e.g., PLMN1) and that NR band 41 and NR band 77 are supported by the UE for EN-DC operation for a second PLMN (e.g., PLMN2). Further, SIB26a information (included in the column identified as “SIB26A based NR band list”) indicates that the network supports NR band 4 and NR band 8 for the first PLMN and supports NR band 9 and NR band 10 for the second PLMN. Here, there are no NR bands supported by both the UE and the network for EN-DC operation in the first cell on the first PLMN or on the second PLMN (as indicated in the column identified as “NR-NSA connectivity on serving band”). Thus, the MR-DC connectivity information in this case indicates that that no frequency band is available to support EN-DC operation for the first cell on either the first PLMN or on the second PLMN. As a result, the UE may not consider the first cell for EN-DC connectivity on either the first PLMN or the second PLMN (e.g., the UE may assign the first cell a low priority on the first PLMN and the second PLMN).

As another particular example, with respect to a second cell (corresponding to the row identified as “Band-2” in FIG. 4C), the UE capability information indicates that NR band 3 and NR band 7 are supported by the UE for EN-DC operation for the first PLMN and that NR band 6 and NR band 41 are supported by the UE for EN-DC operation for the second PLMN. Further, SIB26a information indicates that the network supports NR bands 3, 4, 5, 6, 7 and 8 for the first PLMN and supports NR bands 9, 10, 11, and 12 for the second PLMN. Here, there are two NR bands (NR bands 3 and 7) supported by both the UE and the network for EN-DC operation in the second cell on the first PLMN. Further, there are no NR bands supported by both the UE and the network for EN-DC operation in the second cell on the second PLMN. Thus, the MR-DC connectivity information in this case indicates that at least one frequency band is available to support EN-DC operation for the second cell on the first PLMN, and that no frequency band is available to support EN-DC operation for the second cell on the second PLMN. As a result, the UE may consider the second cell for EN-DC connectivity on the first PLMN (e.g., the UE may assign the second cell a high priority on the first PLMN), and may not consider the second cell for EN-DC connectivity on the second PLMN (e.g., the UE may assign the second cell a low priority on the second PLMN).

As another particular example, with respect to a third cell (corresponding to the row identified as “Band-3” in FIG. 4C), the UE capability information indicates that NR band 3 and NR band 5 are supported by the UE for EN-DC operation for the first PLMN and that NR band 41 and NR band 77 are supported by the UE for EN-DC operation for the second PLMN. Further, SIB26a information indicates that the network supports NR bands 3, 4, 5, 6, 7 and 8 for the first PLMN and supports NR bands 40 and 41 for the second PLMN. Here, there are two NR bands (NR bands 3 and 5) supported by both the UE and the network for EN-DC operation in the third cell on the first PLMN. Further, there is one NR band (NR band 41) supported by both the UE and the network for EN-DC operation in the third cell on the second PLMN. Thus, the MR-DC connectivity information in this case indicates that at least one frequency band is available to support EN-DC operation for the third cell on the first PLMN, and that at least one frequency band is available to support EN-DC operation for the third cell on the second PLMN. As a result, the UE may consider the first cell for EN-DC connectivity on either the first PLMN or the second PLMN (e.g., the UE may assign the first cell a high priority on the first PLMN and the second PLMN).

As indicated above, FIGS. 4A-4C are provided as examples. Other examples may differ from what is described with respect to FIGS. 4A-4C.

FIG. 5 is a diagram illustrating an example process 500 performed, for example, by a UE, in accordance with the present disclosure. Example process 500 is an example where the UE (e.g., UE 120) performs operations associated with dual connectivity cell prioritization.

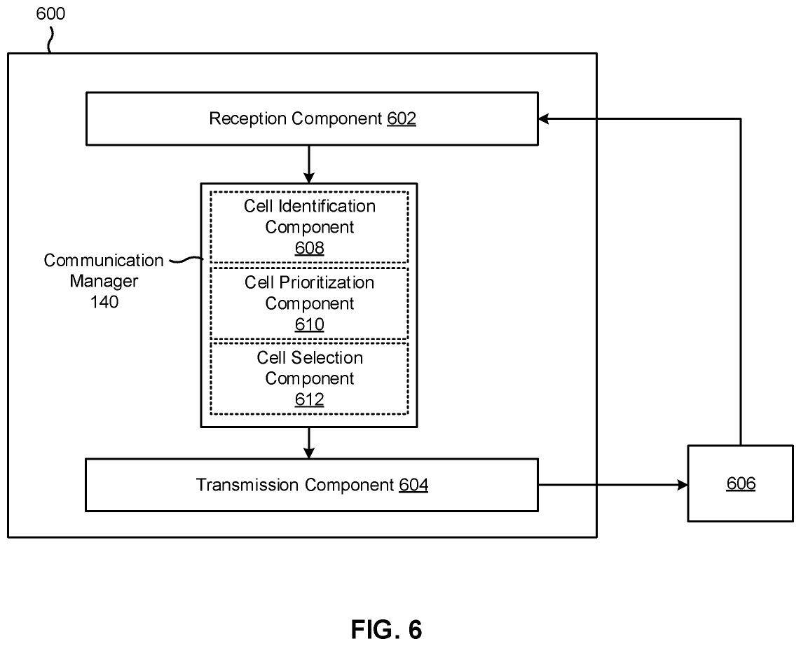

As shown in FIG. 5, in some aspects, process 500 may include identifying an MR-DC capable cell (block 510). For example, the UE (e.g., using communication manager 140 and/or cell identification component 608, depicted in FIG. 6) may identify an MR-DC capable cell, as described above, for example, with reference to FIGS. 4A-4C.

As further shown in FIG. 5, in some aspects, process 500 may include assigning a priority to the MR-DC capable cell based at least in part on at least one of whether information indicating whether dual connectivity is supported for the UE in a TA associated with the MR-DC capable cell is available, the information indicating whether dual connectivity is supported for the UE in the TA associated with the MR-DC capable cell, whether SIB information indicating frequency bands supported by a network for MR-DC operation in the MR-DC capable cell is available, or MR-DC connectivity information, associated with the MR-DC capable cell, indicating whether at least one frequency band is available to support MR-DC operation (block 520). For example, the UE (e.g., using communication manager 140 and/or cell prioritization component 610, depicted in FIG. 6) may assign a priority to the MR-DC capable cell based at least in part on at least one of whether information indicating whether dual connectivity is supported for the UE in a TA associated with the MR-DC capable cell is available, the information indicating whether dual connectivity is supported for the UE in the TA associated with the MR-DC capable cell, whether SIB information indicating frequency bands supported by a network for MR-DC operation in the MR-DC capable cell is available, or MR-DC connectivity information, associated with the MR-DC capable cell, indicating whether at least one frequency band is available to support MR-DC operation, as described above, for example, with reference to FIGS. 4A-4C.

As further shown in FIG. 5, in some aspects, process 500 may include performing a cell selection procedure or a cell reselection procedure based at least in part on the priority assigned to the MR-DC capable cell (block 530). For example, the UE (e.g., using communication manager 140 and/or cell selection component 612, depicted in FIG. 6) may perform a cell selection procedure or a cell reselection procedure based at least in part on the priority assigned to the MR-DC capable cell, as described above, for example, with reference to FIGS. 4A-4C.

Process 500 may include additional aspects, such as any single aspect or any combination of aspects described below and/or in connection with one or more other processes described elsewhere herein.

In a first aspect, process 500 includes determining the MR-DC connectivity information based at least in part on the SIB information indicating the frequency bands supported by the network for MR-DC operation in the MR-DC capable cell and UE capability information indicating frequency bands supported by the UE for MR-DC operation in the MR-DC capable cell.

In a second aspect, alone or in combination with the first aspect, a low priority is assigned to the MR-DC capable cell based at least in part on the information indicating whether dual connectivity is supported for the UE in the TA being available and indicating that dual connectivity is not supported for the UE in the TA.

In a third aspect, alone or in combination with one or more of the first and second aspects, a high priority is assigned to the MR-DC capable cell based at least in part on the information indicating whether dual connectivity is supported for the UE in the TA being unavailable, or being available and indicating that dual connectivity is supported for the UE in the TA, and the SIB information being unavailable.

In a fourth aspect, alone or in combination with one or more of the first through third aspects, a high priority is assigned to the MR-DC capable cell based at least in part on the information indicating whether dual connectivity is supported for the UE in the TA being unavailable, or being available and indicating that dual connectivity is supported for the UE in the TA, the SIB information being available, and the MR-DC connectivity information indicating that at least one frequency band is available to support MR-DC operation.

In a fifth aspect, alone or in combination with one or more of the first through fourth aspects, a low priority is assigned to the MR-DC capable cell based at least in part on the information indicating whether dual connectivity is supported for the UE in the TA being unavailable, or being available and indicating that dual connectivity is supported for the UE in the TA, the SIB information being available, and the MR-DC connectivity information indicating that no frequency band is available to support MR-DC operation.

In a sixth aspect, alone or in combination with one or more of the first through fifth aspects, the MR-DC capable cell is identified based at least in part on a database, stored on the UE, that identifies one or more MR-DC capable cells.

In a seventh aspect, alone or in combination with one or more of the first through sixth aspects, information identifying the MR-DC capable cell is stored in the database based at least in part on an SCG addition associated with the MR-DC capable cell.

In an eighth aspect, alone or in combination with one or more of the first through seventh aspects, information identifying the MR-DC capable cell is stored in the database based at least in part on the UE receiving a measurement configuration for the MR-DC capable cell that is associated with a particular RAT.

In a ninth aspect, alone or in combination with one or more of the first through eighth aspects, information identifying the MR-DC capable cell is stored in the database based at least in part on an upper layer indication received by the UE in SIB2.

In a tenth aspect, alone or in combination with one or more of the first through ninth aspects, the MR-DC capable cell is an EN-DC capable cell.

In an eleventh aspect, alone or in combination with one or more of the first through tenth aspects, the SIB information is associated with SIB26a.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include the communication manager 140. The communication manager 140 may include one or more of a cell identification component 608, a cell prioritization component 610, or a cell selection component 612, among other examples.

In some aspects, the apparatus 600 may be configured to perform one or more operations described herein in connection with FIGS. 4A-4C. Additionally, or alternatively, the apparatus 600 may be configured to perform one or more processes described herein, such as process 500 of FIG. 5. In some aspects, the apparatus 600 and/or one or more components shown in FIG. 6 may include one or more components of the UE described in connection with FIG. 2. Additionally, or alternatively, one or more components shown in FIG. 6 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 600. In some aspects, the reception component 602 may include one or more antennas, a modem, a demodulator, a MIMO detector, a receive processor, a controller/processor, a memory, or a combination thereof, of the UE described in connection with FIG. 2.

The transmission component 604 may transmit communications, such as reference signals, control information, data communications, or a combination thereof, to the apparatus 606. In some aspects, one or more other components of the apparatus 600 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modem, a modulator, a transmit MIMO processor, a transmit processor, a controller/processor, a memory, or a combination thereof, of the UE described in connection with FIG. 2. In some aspects, the transmission component 604 may be co-located with the reception component 602 in a transceiver.

The cell identification component 608 may identify an MR-DC capable cell. The cell prioritization component 610 may assign a priority to the MR-DC capable cell based at least in part on at least one of whether information indicating whether dual connectivity is supported for the UE in a TA associated with the MR-DC capable cell is available, the information indicating whether dual connectivity is supported for the UE in the TA associated with the MR-DC capable cell, whether SIB information indicating frequency bands supported by a network for MR-DC operation in the MR-DC capable cell is available, or MR-DC connectivity information, associated with the MR-DC capable cell, indicating whether at least one frequency band is available to support MR-DC operation. The cell selection component 612 may perform a cell selection procedure or a cell reselection procedure based at least in part on the priority assigned to the MR-DC capable cell.

The cell prioritization component 610 may determine the MR-DC connectivity information based at least in part on the SIB information indicating the frequency bands supported by the network for MR-DC operation in the MR-DC capable cell and UE capability information indicating frequency bands supported by the UE for MR-DC operation in the MR-DC capable cell.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of some Aspects of the present disclosure:

Aspect 1: A method of wireless communication performed by a UE, comprising: identifying an MR-DC capable cell: assigning a priority to the MR-DC capable cell based at least in part on at least one of: whether information indicating whether dual connectivity is supported for the UE in a TA associated with the MR-DC capable cell is available, the information indicating whether dual connectivity is supported for the UE in the TA associated with the MR-DC capable cell, whether SIB information indicating frequency bands supported by a network for MR-DC operation in the MR-DC capable cell is available, or MR-DC connectivity information, associated with the MR-DC capable cell, indicating whether at least one frequency band is available to support MR-DC operation; and performing a cell selection procedure or a cell reselection procedure based at least in part on the priority assigned to the MR-DC capable cell.

Aspect 2: The method of Aspect 1, further comprising determining the MR-DC connectivity information based at least in part on the SIB information indicating the frequency bands supported by the network for MR-DC operation in the MR-DC capable cell and UE capability information indicating frequency bands supported by the UE for MR-DC operation in the MR-DC capable cell.

Aspect 3: The method of any of Aspects 1-2, wherein a low priority is assigned to the MR-DC capable cell based at least in part on the information indicating whether dual connectivity is supported for the UE in the TA being available and indicating that dual connectivity is not supported for the UE in the TA.

Aspect 4: The method of any of Aspects 1-2, wherein a high priority is assigned to the MR-DC capable cell based at least in part on: the information indicating whether dual connectivity is supported for the UE in the TA being unavailable, or being available and indicating that dual connectivity is supported for the UE in the TA, and the SIB information being unavailable.

Aspect 5: The method of any of Aspects 1-2, wherein a high priority is assigned to the MR-DC capable cell based at least in part on: the information indicating whether dual connectivity is supported for the UE in the TA being unavailable, or being available and indicating that dual connectivity is supported for the UE in the TA, the SIB information being available, and the MR-DC connectivity information indicating that at least one frequency band is available to support MR-DC operation.

Aspect 6: The method of any of Aspects 1-2, wherein a low priority is assigned to the MR-DC capable cell based at least in part on: the information indicating whether dual connectivity is supported for the UE in the TA being unavailable, or being available and indicating that dual connectivity is supported for the UE in the TA, the SIB information being available, and the MR-DC connectivity information indicating that no frequency band is available to support MR-DC operation.

Aspect 7: The method of any of Aspects 1-6, wherein the MR-DC capable cell is identified based at least in part on a database, stored on the UE, that identifies one or more MR-DC capable cells.

Aspect 8: The method of Aspect 7, wherein information identifying the MR-DC capable cell is stored in the database based at least in part on a secondary cell group (SCG) addition associated with the MR-DC capable cell.

Aspect 9: The method of any of Aspects 7-8, wherein information identifying the MR-DC capable cell is stored in the database based at least in part on the UE receiving a measurement configuration for the MR-DC capable cell that is associated with a particular RAT.

Aspect 10: The method of any of Aspects 7-9, wherein information identifying the MR-DC capable cell is stored in the database based at least in part on an upper layer indication received by the UE in SIB2.

Aspect 11: The method of any of Aspects 1-10, wherein the MR-DC capable cell is an EN-DC capable cell.

Aspect 12: The method of any of Aspects 1-11, wherein the SIB information is associated with SIB26a.

Aspect 13: An apparatus for wireless communication at a device, comprising a processor; memory coupled with the processor; and instructions stored in the memory and executable by the processor to cause the apparatus to perform the method of one or more of Aspects 1-12.

Aspect 14: A device for wireless communication, comprising a memory and one or more processors coupled to the memory, the one or more processors configured to perform the method of one or more of Aspects 1-12.

Aspect 15: An apparatus for wireless communication, comprising at least one means for performing the method of one or more of Aspects 1-12.

Aspect 16: A non-transitory computer-readable medium storing code for wireless communication, the code comprising instructions executable by a processor to perform the method of one or more of Aspects 1-12.

Aspect 17: A non-transitory computer-readable medium storing a set of instructions for wireless communication, the set of instructions comprising one or more instructions that, when executed by one or more processors of a device, cause the device to perform the method of one or more of Aspects 1-12.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
identify a multi-radio access technology (multi-RAT) dual connectivity (DC) (MR-DC) capable cell;
assign a priority to the MR-DC capable cell based at least in part on at least one of:
whether information indicating whether dual connectivity is supported for the UE in a tracking area (TA) associated with the MR-DC capable cell is available,
the information indicating whether dual connectivity is supported for the UE in the TA associated with the MR-DC capable cell,
whether system information block (SIB) information indicating frequency bands supported by a network for MR-DC operation in the MR-DC capable cell is available, or
MR-DC connectivity information, associated with the MR-DC capable cell, indicating whether at least one frequency band is available to support MR-DC operation; and
perform a cell selection procedure or a cell reselection procedure based at least in part on the priority assigned to the MR-DC capable cell.

2. The UE of claim 1, wherein the one or more processors are further configured to determine the MR-DC connectivity information based at least in part on the SIB information indicating the frequency bands supported by the network for MR-DC operation in the MR-DC capable cell and UE capability information indicating frequency bands supported by the UE for MR-DC operation in the MR-DC capable cell.

3. The UE of claim 1, wherein a low priority is assigned to the MR-DC capable cell based at least in part on the information indicating whether dual connectivity is supported for the UE in the TA being available and indicating that dual connectivity is not supported for the UE in the TA.

4. The UE of claim 1, wherein a high priority is assigned to the MR-DC capable cell based at least in part on:
the information indicating whether dual connectivity is supported for the UE in the TA being unavailable, or being available and indicating that dual connectivity is supported for the UE in the TA, and
the SIB information being unavailable.

5. The UE of claim 1, wherein a high priority is assigned to the MR-DC capable cell based at least in part on:
the information indicating whether dual connectivity is supported for the UE in the TA being unavailable, or being available and indicating that dual connectivity is supported for the UE in the TA,
the SIB information being available, and
the MR-DC connectivity information indicating that at least one frequency band is available to support MR-DC operation.

6. The UE of claim 1, wherein a low priority is assigned to the MR-DC capable cell based at least in part on:
the information indicating whether dual connectivity is supported for the UE in the TA being unavailable, or being available and indicating that dual connectivity is supported for the UE in the TA,
the SIB information being available, and
the MR-DC connectivity information indicating that no frequency band is available to support MR-DC operation.

7. The UE of claim 1, wherein the MR-DC capable cell is identified based at least in part on a database, stored on the UE, that identifies one or more MR-DC capable cells.

8. The UE of claim 7, wherein information identifying the MR-DC capable cell is stored in the database based at least in part on a secondary cell group (SCG) addition associated with the MR-DC capable cell.

9. The UE of claim 7, wherein information identifying the MR-DC capable cell is stored in the database based at least in part on the UE receiving a measurement configuration for the MR-DC capable cell that is associated with a particular RAT.

10. The UE of claim 7, wherein information identifying the MR-DC capable cell is stored in the database based at least in part on an upper layer indication received by the UE in SIB2.

11. The UE of claim 1, wherein the MR-DC capable cell is an Evolved Universal Terrestrial Radio Access Network (EUTRAN) New Radio (NR) dual connectivity (EN-DC) capable cell.

12. The UE of claim 1, wherein the SIB information is associated with SIB26a.

13. A method of wireless communication performed by a user equipment (UE), comprising:
identifying a multi-radio access technology (multi-RAT) dual connectivity (DC) (MR-DC) capable cell;
assigning a priority to the MR-DC capable cell based at least in part on at least one of:
whether information indicating whether dual connectivity is supported for the UE in a tracking area (TA) associated with the MR-DC capable cell is available,
the information indicating whether dual connectivity is supported for the UE in the TA associated with the MR-DC capable cell,
whether system information block (SIB) information indicating frequency bands supported by a network for MR-DC operation in the MR-DC capable cell is available, or
MR-DC connectivity information, associated with the MR-DC capable cell, indicating whether at least one frequency band is available to support MR-DC operation; and
performing a cell selection procedure or a cell reselection procedure based at least in part on the priority assigned to the MR-DC capable cell.

14. The method of claim 13, further comprising determining the MR-DC connectivity information based at least in part on the SIB information indicating the frequency bands supported by the network for MR-DC operation in the MR-DC capable cell and UE capability information indicating frequency bands supported by the UE for MR-DC operation in the MR-DC capable cell.

15. The method of claim 13, wherein a low priority is assigned to the MR-DC capable cell based at least in part on the information indicating whether dual connectivity is supported for the UE in the TA being available and indicating that dual connectivity is not supported for the UE in the TA.

16. The method of claim 13, wherein a high priority is assigned to the MR-DC capable cell based at least in part on:
the information indicating whether dual connectivity is supported for the UE in the TA being unavailable, or being available and indicating that dual connectivity is supported for the UE in the TA, and
the SIB information being unavailable.

17. The method of claim 13, wherein a high priority is assigned to the MR-DC capable cell based at least in part on:
the information indicating whether dual connectivity is supported for the UE in the TA being unavailable, or being available and indicating that dual connectivity is supported for the UE in the TA,
the SIB information being available, and
the MR-DC connectivity information indicating that at least one frequency band is available to support MR-DC operation.

18. The method of claim 13, wherein a low priority is assigned to the MR-DC capable cell based at least in part on:
the information indicating whether dual connectivity is supported for the UE in the TA being unavailable, or being available and indicating that dual connectivity is supported for the UE in the TA,
the SIB information being available, and
the MR-DC connectivity information indicating that no frequency band is available to support MR-DC operation.

19. The method of claim 13, wherein the MR-DC capable cell is identified based at least in part on a database, stored on the UE, that identifies one or more MR-DC capable cells.

20. The method of claim 19, wherein information identifying the MR-DC capable cell is stored in the database based at least in part on a secondary cell group (SCG) addition associated with the MR-DC capable cell.

21. The method of claim 19, wherein information identifying the MR-DC capable cell is stored in the database based at least in part on the UE receiving a measurement configuration for the MR-DC capable cell that is associated with a particular RAT.

22. The method of claim 19, wherein information identifying the MR-DC capable cell is stored in the database based at least in part on an upper layer indication received by the UE in SIB2.

23. The method of claim 13, wherein the MR-DC capable cell is an Evolved Universal Terrestrial Radio Access Network (EUTRAN) New Radio (NR) dual connectivity (EN-DC) capable cell.

24. The method of claim 13, wherein the SIB information is associated with SIB26a.

25. A non-transitory computer-readable medium storing a set of instructions for wireless communication, the set of instructions comprising:
one or more instructions that, when executed by one or more processors of a user equipment (UE), cause the UE to:
identify a multi-radio access technology (multi-RAT) dual connectivity (DC) (MR-DC) capable cell;
assign a priority to the MR-DC capable cell based at least in part on at least one of:
whether information indicating whether dual connectivity is supported for the UE in a tracking area (TA) associated with the MR-DC capable cell is available,
the information indicating whether dual connectivity is supported for the UE in the TA associated with the MR-DC capable cell,
whether system information block (SIB) information indicating frequency bands supported by a network for MR-DC operation in the MR-DC capable cell is available, or
MR-DC connectivity information, associated with the MR-DC capable cell, indicating whether at least one frequency band is available to support MR-DC operation; and
perform a cell selection procedure or a cell reselection procedure based at least in part on the priority assigned to the MR-DC capable cell.

26. The non-transitory computer-readable medium of claim 25, wherein the one or more instructions further cause the UE to determine the MR-DC connectivity information based at least in part on the SIB information indicating the frequency bands supported by the network for MR-DC operation in the MR-DC capable cell and UE capability information indicating frequency bands supported by the UE for MR-DC operation in the MR-DC capable cell.

27. The non-transitory computer-readable medium of claim 25, wherein the MR-DC capable cell is identified based at least in part on a database, stored on the UE, that identifies one or more MR-DC capable cells.

28. An apparatus for wireless communication, comprising:
means for identifying a multi-radio access technology (multi-RAT) dual connectivity (DC) (MR-DC) capable cell;
means for assigning a priority to the MR-DC capable cell based at least in part on at least one of:
whether information indicating whether dual connectivity is supported for the apparatus in a tracking area (TA) associated with the MR-DC capable cell is available,
the information indicating whether dual connectivity is supported for the apparatus in the TA associated with the MR-DC capable cell,
whether system information block (SIB) information indicating frequency bands supported by a network for MR-DC operation in the MR-DC capable cell is available, or
MR-DC connectivity information, associated with the MR-DC capable cell, indicating whether at least one frequency band is available to support MR-DC operation; and
means for performing a cell selection procedure or a cell reselection procedure based at least in part on the priority assigned to the MR-DC capable cell.

29. The apparatus of claim 28, further comprising means for determining the MR-DC connectivity information based at least in part on the SIB information indicating the frequency bands supported by the network for MR-DC operation in the MR-DC capable cell and UE capability information indicating frequency bands supported by the apparatus for MR-DC operation in the MR-DC capable cell.

30. The apparatus of claim 28, wherein the MR-DC capable cell is identified based at least in part on a database, stored on the apparatus, that identifies one or more MR-DC capable cells.
